(19) United States
(12) Patent Application Publication
(10) Pub. No.: US 2013/0339164 A1
(43) Pub. Date: Dec. 19, 2013

(54) SYSTEM AND METHOD FOR ADAPTIVE PREDIAL

(71) Applicants: Christopher A. LoPresto, Biloxi, MS (US); David A. Berg, Long Beach, MS (US)

(72) Inventors: Christopher A. LoPresto, Biloxi, MS (US); David A. Berg, Long Beach, MS (US)

(73) Assignee: Triton Systems of Delaware, LLC, Long Beach, MS (US)

(21) Appl. No.: 13/495,851

(22) Filed: Jun. 13, 2012

(51) Int. Cl. G06Q 20/20

(52) U.S. Cl. 705/16

(57) ABSTRACT

A method for adapting the amount of predial delay in a terminal, such as an automatic teller machine (ATM) system, based upon actual connection times with a host over a telecommunications network experienced by the ATM in a particular installation. The ATM may adjust the point in the customer transaction process at which it initiates a connection with a host in order to decrease the wait time experienced by a customer while a connection with the host is established, as well as wait time by the host after a connection is established while a transaction request message is being prepared.

### TECHNICAL FIELD

This disclosure relates generally to the field of terminals that communicate with a host to process a financial transaction, including for example automatic teller machines (ATMs) and point-of-sale (POS) terminals.

### BACKGROUND

In order for an ATM or other terminal to process a financial transaction requested by a customer, the device must communicate with a financial institution or other entity, and more particularly with a computer system at such an entity. Any such entity or computer system associated with such an entity, or intermediate entity or system with which an ATM or terminal communicates to process a customer transaction, shall be referred to herein as a Host. Any financial terminal, including an ATM, POS, or similar terminal that communicates with a Host to process a financial transaction, will be referred to herein as an ATM. An ATM may initiate a connection over a communications network with a Host in response to customer activity, such as a customer inserting his card into the ATM, or entering his personal identification number (PIN) into the ATM to begin a transaction. An ATM may use a modem or other communications hardware to establish the connection. The ATM initiates a communication to a logical or virtual address associated with the Host. With a modem, an ATM addresses the Host and initiates the connection by dialing a telephone number for the Host. The ATM may also address the Host using other hardware and addressing means known in the art. The term modem will be used in this disclosure to refer to any communications hardware or module used by an ATM to establish a connection with a Host, and the process for addressing the Host for such a point-to-point connection shall be referred to herein as dialing, even where hardware other than a modem is used, and even where the connection is established without access to telephone lines.

A typical ATM may include an output device such as a video display for communicating with a customer or an operator, an input device such as a keypad or touchscreen display, a card reader mechanism for reading a customer's ATM card, a cash dispenser mechanism, a depository mechanism for accepting deposits into the machine, a receipt printer, a modem or other communications hardware for interfacing with a Host via a communications network, and a computer system in operative communication and control of the foregoing components for processing input and output, performing tasks, and communicating with the Host. The computer system contains a processor, a memory for storing software containing instructions for execution by the processor, including an operating system and application software. As is understood to those of ordinary skill in the art, certain of the components also may include a processor and memory for storing software (sometimes referred to as firmware). The ATM processor, running the operating system and application software, communicates with and controls the foregoing devices to cause them to correctly perform their respective functions, including communicating with the modem or other communications hardware, to cause it to communicate with external systems over a communications network, using protocols suitable to that network. Where it is stated herein that an ATM communicates with or establishes a connection with a Host, or vice versa, it should be understood that the communication occurs through the software and hardware of the ATM, of which the modem and associated software, or other communications hardware and software, are an operative part. Further, while the foregoing description is applicable to an ATM that processes banking transactions, not all banking ATMs will have all such components (such as the depository mechanism), and the principles of the invention disclosed herein are applicable to other secure terminals that process financial transactions that do not contain a cash dispenser, such as a terminal in a gasoline pump.

A typical ATM transaction process is illustrated in the top half of FIG. 1. A customer inserts his card into the ATM at step 10, to begin the transaction. In step 20, the ATM starts processing in response to the insertion of the card, and in step 30, the ATM receives input from the customer for the transaction, beginning usually with the customer's entering his PIN and then selecting the type and entering the amount of the transaction. Then ATM then builds a request message for the Host containing data for the financial transaction requested by the customer in step 30. The ATM in step 50 checks to see if it is connected to the Host, and if a connection to the Host is established, it sends the request message to the Host in step 60.

At some point in the foregoing transaction process, the ATM must initiate and establish a connection to the Host. To do so, the ATM dials the phone number for the Host, negotiates a connection with the Host, and awaits a ready (or similar) signal from the Host indicating it is ready to receive a request from the ATM. The ATM then sends the request message, receives a transaction response from the Host, and acts accordingly (dispenses cash, displays balance, prints receipt, etc.). In this process, if the ATM initiates communication with the Host after the customer has completed the transaction selection process, the customer must wait while the ATM dials the host number, negotiates the connection, performs necessary authentication with the Host, and then finally receives the transaction response from the Host.

Alternately, an option called “predial” can be enabled to allow the dialing process to start sooner in the transaction selection process by the customer (for example, after the card is inserted or after the PIN is entered). One problem with using such a “predial” option is that the time it takes to negotiate a dialup (or other) connection with a host processor, referred to herein as the connection time, will vary based on the particular phone line system (or other communications network) to which the ATM is connected, modems, and the host processing software. As noted, the ATM begins communicating data with the Host after receiving a ready signal from the Host. A ready signal in standard communications protocols used by ATMs, and known to those of ordinary skill in the art, is often referred to as an ENQ. If the Host issues the ENQ signal and does not receive a response from the ATM, the Host will wait some time period, usually several seconds, before issuing another ENQ signal. Thus, if the ATM begins the predial process too soon, and receives the ENQ from the Host before the customer transaction request is ready, then the ATM (and the customer) must wait until for the Host to issue the next ENQ to begin transferring data. If the connection time is very short, or the predial process begins much too soon, then it is possible the connection could complete and the Host could hang up on the ATM after a timeout period, while the ATM is waiting for the customer to finish entering his transaction. This would then cause the ATM to redial and cause further delay while customer is waiting.

An ATM owner may be charged fees for connect time by the telephone company or owner of the telecommunications network over which these communications take place. Terminated connections that must be reestablished, such as in the hang-up example above, or time elapsed while the ATM waits on the Host when the connection is established too early, may cause an ATM owner to incur unnecessary fees. Wait times also may cause customer dissatisfaction.

Thus, there is a need for a method and system to optimize the amount of predial delay in an ATM to decrease the amount of time an ATM customer must wait while transaction information is sent to a Host. There is a further need to adapt the amount of predial delay to communications conditions specific to a given ATM.

### SUMMARY

Embodiments of the present invention satisfy these needs, although it is to be understood that not every embodiment described herein will address a given need. In one embodiment, in which in which an ATM, at a defined start point, initiates and establishes a connection to a host via a communications network in response to customer activity, the ATM computes the time for a connection to be established between the ATM and the host and determines whether the start point should be adjusted based upon a relationship between the connection time and a defined transaction time value. The defined transaction time value may be representative of time elapsed while a transaction is entered into said ATM by a customer, and, in one embodiment, is representative of a minimum amount of time for a customer to enter a transaction into the ATM. The relationship between the connection time and the defined transaction time value may be defined by a composite connection time value that is determined from a statistical analysis of connection times from a plurality of preceding customer transactions. If the composite connection time value is less than the defined transaction time value, the start point may be delayed by the difference between them. The statistical analysis from which the composite connection time is determined may comprise computing the mean, median, or mode of the connection times for a connection to be established between the ATM and the host from a plurality of preceding customer transactions. This plurality of preceding transactions may be a defined set of preceding transactions, such as all transactions from a specified preceding time period (including all transactions for which a connection time was computed), a specified number of preceding transactions, and transactions from a specified day-part corresponding to the current transaction.

### BRIEF DESCRIPTION OF THE DRAWINGS

The present invention will be explained, by way of example only, with reference to certain embodiments and the attached figures, in which:

FIG. 1 is a block diagram showing some aspects of a dialing process with respect to a transaction process; and

FIG. 2 is a flowchart showing steps of one embodiment of the method of the present invention.

### DETAILED DESCRIPTION

Embodiments of the present invention provide a method for adapting the amount of predial delay in an ATM based upon actual connection times computed by the ATM in a particular installation. In one embodiment, the ATM adjusts the point in the customer transaction process at which it initiates a connection with a Host, in order to establish a connection with the Host close in time to the point at which a request message from a customer transaction is ready to be sent to the Host. This process decreases, and preferably minimizes, the wait time experienced by a customer while a connection to the Host is established. It also decreases, and preferably minimizes, the time elapsed on an established connection with the Host waiting on an ATM before the ATM is ready to send a request message. This disclosure will use the term ATM both generally to refer to any financial terminal, or other client, communications device, network endpoint, or node that communicates with a Host to process a transaction, including a financial transaction, as a well as in an exemplary manner to describe an automated teller machine.

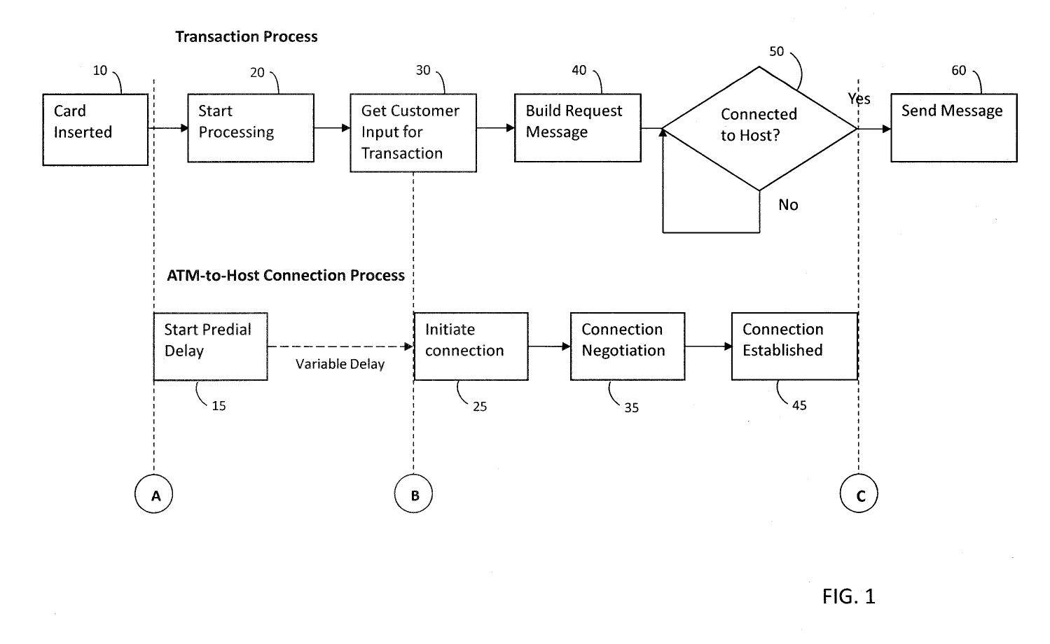

The lower half of FIG. 1 illustrates a connection process between an ATM and a Host, including a variable predial delay, with respect to a typical customer transaction process shown in the upper half of the figure, described above. Timing of the two processes with respect to one another, as taught by an embodiment of the present invention, is illustrated. In step 25, an ATM initiates a connection to the Host, and the connection is negotiated and established in steps 35 and 45. The ATM begins the process to initiate the connection to the Host at a start point denoted by the line B in FIG. 1, and the connection is established and the Host signals it is ready to receive a request message from the ATM at an end point denoted by line C in FIG. 1. An object of this embodiment of the invention is to adjust the timing of point B, with respect to the transaction process, so that point C occurs close in time to when the request message is ready to be sent. A delay is introduced before point B, and this delay is varied as described herein to adjust the positions of point B and C relative to the transaction process. This variable delay is measured from a beginning point denoted by line A in FIG. 1, which in a preferred embodiment, is the earliest point in the transaction process that the ATM can respond to customer activity to initiate the connection process. The delay following point A, before start point B, is referred to herein as predial delay, and variation in the length of that delay may be referred to as the adaptive predial process.

In one embodiment, a transaction time value is defined to serve as a benchmark for the adaptive predial process. As discussed below, ATM-to-Host connection time (or, in some embodiments, a composite connection time value derived from a statistical analysis of connection times) is compared to this transaction time value to determine whether the predial delay should be adjusted. The transaction time value may be representative of time elapsed while a transaction is entered into the ATM, and, in a preferred embodiment, the transaction time value is representative of the minimum time to enter a transaction into the ATM. This may be determined empirically in a controlled setting by having an individual familiar with the ATM interface enter a basic transaction as quickly as possible. This normally entails inserting or sliding an ATM card into or through a magnetic card reader on the ATM, entering a PIN, and selecting a transaction that is likely to be the fastest transaction available (such as “fast cash” that is commonly available on many ATMs). The transaction time value therefore may vary according to the particular software interface and available features or transactions available on a given ATM. In measuring a minimum transaction time, the beginning of the measurement can be defined as the point at which the ATM reads a customer's card, the point at which the PIN is successfully entered, or other predefined beginning point. As noted, this transaction time value will be compared to the ATM-to-Host connection time, or a value derived from such connection time. To achieve more accurate results, the beginning point when measuring the minimum transaction time should not be later than the earliest point at which the ATM could begin dialing the Host in response to customer activity, and therefore could coincide with point A on FIG. 1. The transaction time value also may be determined from measurement and statistical analysis of actual customer transaction times, the minimum actual customer transaction time measured over a predefined time period, or may be set to a predefined value as required or needed for a particular installation.

The time taken for a connection to be established between an ATM and a Host is referred to herein as the connection time. The connection time may be measured based upon any two defined points that are indicative of the time elapsed in initiating, negotiating, and establishing a connection with the Host. In ATMs using a modem to connect to a Host by dialing a phone number for the Host over a telephone line, the connection process may be defined to begin, for example, with the modem going “off hook,” the beginning of dialing, or other selected point in the dialing process. The point at which the ATM initiates the connection process with the Host, however defined, is referred to herein as the start point, and in one embodiment, may be represented by point B on FIG. 1. Likewise, the ending point selected for when a connection to the Host has been established may be defined as best suits a particular application, such as when the Host picks up the call or sends the first acknowledgement of the call or a ready signal, such as in the form of an ENQ. In one embodiment, the end point may be represented by point C on FIG. 1. The connection time is computed by calculating the difference between the defined start point and end point for initiating and establishing a connection between the ATM and Host, that is, the difference in time between points B and C. As used herein, the term computing refers to steps performed by a processor of the ATM, or a processor of a component of the ATM such as a communications module, executing instructions of a software program (and not to operations performed manually or by a human mind).

Predial delay entails determining where the start point of the ATM-to-Host connection process should be with respect to customer activity in engaging in a financial transaction through the ATM. Such customer activity typically includes inserting or sliding an ATM card into or through a magnetic card reader on the ATM, entering a PIN, and selecting a transaction. Customer activity also includes other interaction or communication between the customer and the ATM, as well as such interaction and communication that may be developed or implemented in future, for example, on ATMs that use authentication measures other than a magnetic card and PIN. The start point may be defined to be at any desired point in response to customer activity, but the initial start point is preferably set to be early in the financial transaction process. The predial delay at the initial start point is defined to be zero. In one embodiment, a customer's inserting his card defines the initial start point, with predial delay set to zero (such that points A and B on FIG. 1 would coincide). Applying an embodiment of the method of the present invention, the predial delay is then adjusted in order to decrease, and preferably minimize, customer wait time while the ATM-to-Host connection is established, as well as to decrease, and preferably minimize time elapsed after the connection is established with the Host waiting on the ATM while a request message is being built from customer input, which may reduce connection charges. Referring to FIG. 1, the result is that point B moves out in time from point A so that point C preferably coincides with the request message being ready to be sent.

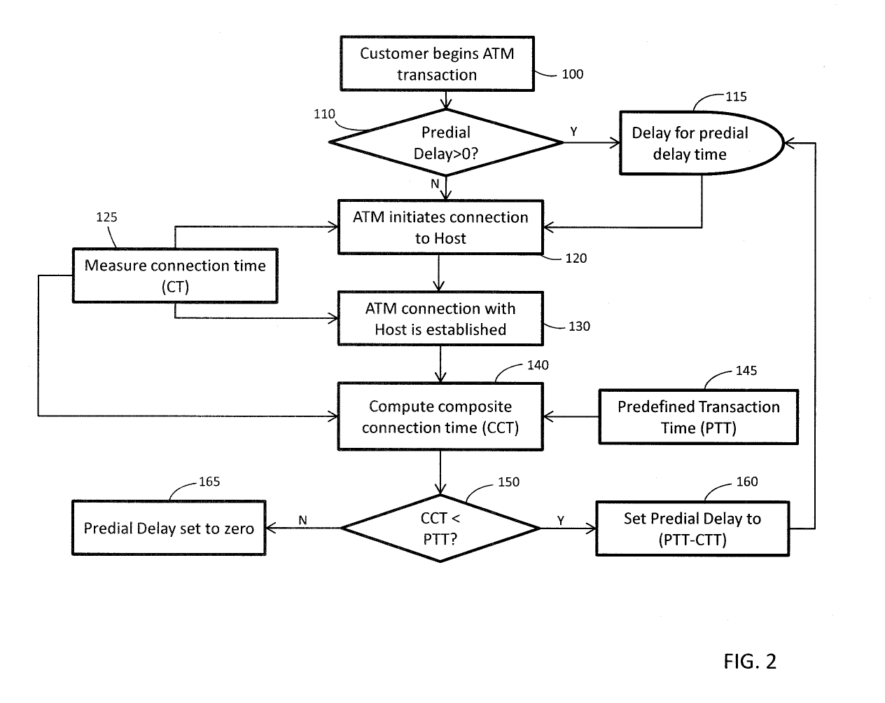

FIG. 2 is a flowchart illustrating one embodiment of a method of the present invention. In step 100, the customer begins the financial transaction with the ATM. Then, in step 110, in response to the customer activity, the ATM determines whether the current predial delay is greater than zero. As noted, the initial start point of the connection process will typically be defined to be early in the transaction process, and the initial value of the predial delay will be zero. If the current predial delay value is greater than zero, the ATM in step 115 will delay for the specified time, and then proceed to step 120. If the predial delay value is zero, then the ATM proceeds to step 120 without a predial delay. In step 120, the ATM initiates the connection to the Host. The ATM then negotiates a connection to the Host, and the connection is established at step 130. In step 125, the ATM measures the time for a connection to be established between the ATM and the Host, i.e., the connection time.

In step 140, the ATM computes a composite connection time (CCT) which is based on a relationship between the measured connection time from step 125 and the predetermined transaction time value (PTT). As described above, the PTT is a benchmark time value, which typically is representative of the time it takes a customer to enter a transaction into the ATM and may be the minimum customer transaction time. The CCT is a value based upon a statistical analysis of a plurality of previous connection times, discussed below.

In step 150, the ATM compares the CCT and PTT. If the CCT is less than the PTT, then in step 160, the predial delay is set to the difference between the values, for the next customer transaction. If the CCT is not less than the PTT, then the predial delay may be set to zero, in step 165.

In one embodiment, the CCT is the average of a defined set of connection times, including the currently measured connection time. Thus, as part of each customer transaction, the connection time is measured and the average connection time is computed and updated. The CCT may also be based upon the median, mode, or other statistically meaningful measure of a defined set of previous connection times. A plurality of defined sets of connection times may be used. The defined set of previous connection times may be all prior connection times, a specified number of prior connection times (the preceding 10 connection times, 100 connection times, 1000 connection times, etc), the connection times for a specified time period (connection times from the same day, the preceding twenty-four hours, the preceding seven days, the preceding month, the preceding 365 days, etc.), or the connection times for a particular portion of the day corresponding to the current transaction, which is referred to herein as a day-part. That is, the statistical measure for the composite connection time is evaluated based on connection times occurring during the same hour of the same day or of the same hour of the same day of the week; or during business hours (e.g., 7 AM to 5:30 PM), evening hours (e.g., 5:30 PM to midnight), night hours (midnight to 7 AM); or other day-part corresponding to the current transaction. For example, an ATM operator may learn that network traffic for a particular ATM installation peaks at certain hours of the day and define the day-part accordingly. Thus, the day-part may be defined to represent connections that occurred during network conditions most similar to those of the current transaction. In embodiments where a plurality of defined sets of connections times are used, a value of predial delay specific to each defined set may be stored, used, and updated.

Customers with bank accounts serviced by different Hosts may use the ATM, and in some cases, different transaction types may require the ATM to connect to different Hosts. As a result, the ATM may connect with a plurality of hosts over time. The Host identity may be determined based upon reading data from the customer's card upon insertion, or additional input from the customer relating to the transaction may be necessary to identify the Host to which the connection must be made. The earliest point at which a connection to the host could be initiated (where the predial is zero), corresponding to point A on FIG. 1, may vary in those instances in which the Host identity depends on receiving input related to the transaction. Connection times also may vary depending on the Host. The ATM may therefore apply an embodiment of the method of the present invention to each host. The ATM defines and stores a start point specific to each Host, and also computes a composite connection time specific to each host. When the ATM identifies the Host to which it must connect to process the transaction, and it uses the predial delay and defined start point specific to that Host in the connection process with that Host. The ATM then updates the composite connection time specific to that Host and evaluates whether the defined start point for that Host should be adjusted, as described above.

Embodiments of the foregoing method may be implemented as instructions in a software program stored in memory of the ATM, to be performed by the processor of the ATM, in conjunction with a modem or other communications hardware. The foregoing method also may be implemented directly in hardware of the ATM, for example, in the modem.

The administrative functions of the software of the ATM may be configured to allow the user to select the basis for computation of predial delay (e.g., specify a PPT and the method of computing CCT, as described above). The administrative functions also may be configured to allow the predial delay to be reset, for example, if the ATM is installed in a new location or the network connection to the Host is changed.

Although the present invention has been described and shown with reference to certain preferred embodiments thereof, other embodiments are possible. As noted, the term ATM as used herein should be construed to include other terminals and communications devices, including point-of-sale terminals, and may also include personal digital devices, including smartphones, portable computers, and the like, when used to communicate with a host to process a transaction, including a financial transaction. The foregoing description is therefore considered in all respects to be illustrative and not restrictive. Therefore, the present invention should be defined with reference to the claims and their equivalents, and the spirit and scope of the claims should not be limited to the description of the preferred embodiments contained herein.

What is claimed is:

1. In an automated teller machine (ATM) system in which an ATM, at a defined start point, initiates and establishes a connection to a host via a communications network in response to customer activity, a method comprising:
computing the time for a connection to be established between said ATM and said host, said computed time being a connection time;
determining whether said start point should be adjusted based upon a relationship between said connection time and a defined transaction time value.

2. The method of claim 1, wherein said defined transaction time value is representative of time elapsed while a transaction is entered into said ATM by a customer.

3. The method of claim 2, wherein said defined transaction time value is representative of a minimum amount of time for a customer to enter a transaction into the ATM.

4. The method of claim 1, wherein said computing step comprises measuring the time elapsed from said defined start point until a first ready signal is received from said host.

5. The method of claim 1, wherein said relationship is defined by a composite connection time value determined from a statistical analysis of connection times from a plurality of preceding customer transactions.

6. The method of claim 5, wherein said start point is delayed by the difference between said composite connection time value and said defined transaction time value, if said composite connection time value is less than said defined transaction time value.

7. The method of claim 5, wherein said statistical analysis is selected from the group consisting of the mean, median, and mode of the connection times for a connection to be established between said ATM and said host from a plurality of preceding customer transactions.

8. The method of claim 7, wherein said plurality of preceding transactions comprise a defined set of preceding transactions.

9. The method of claim 8, wherein said defined set is selected from the group consisting of:
all transactions from a specified preceding time period; a specified number of preceding transactions; and transactions from a specified day-part corresponding to the current transaction.

10. The method of claim 9, wherein said defined start point is specific to said defined set of transactions.

11. The method of claim 6, wherein there are a plurality of hosts and further comprising storing a defined start point and composite connection time specific to each of said hosts, and wherein said determining step is performed with respect to the defined start point and composite connection time for the host to which said ATM connected in response to said customer activity.

12. The method of claim 6, wherein said defined start point is reset to an initial value if said composite connection time value is not less than said defined transaction time value.

13. An ATM comprising a processor and memory, said memory storing a program of software instructions that when executed by the processor cause the ATM to be operable to initiate at a defined start point a connection to a host via a communications network in response to customer activity, to measure the time for a connection to be established between said ATM and a host, said measured time being a connection time, and to determine whether said start point should be adjusted based upon a relationship between said connection time and a defined transaction time value.

14. The ATM of claim 13, wherein said defined transaction time value is representative of a minimum amount of time for a customer to enter, a transaction into the ATM.

15. The ATM of claim 13, wherein said relationship is defined by a composite connection time value determined from a statistical analysis of connection times from a plurality of preceding customer transactions.

16. The ATM of claim 15, wherein said ATM is operable to delay said start point by the difference between said composite connection time value and said defined transaction time value, if said composite connection time value is less than said defined transaction time value.

17. The ATM of claim 16, wherein said defined start point is reset to an initial value if said composite connection time value is not less than said defined transaction time value.
